(19) United States
(12) Patent Application Publication
(10) Pub. No.: US 2014/0119554 A1
(43) Pub. Date: May 1, 2014

(54) METHODS AND SYSTEMS FOR NON-VOLATILE MEMORY IN WIRELESS HEADSETS

(71) Applicant: ELWHA LLC, Bellevue, WA (US)

(72) Inventors: Alistair K. Chan, Bainbridge Island, WA (US); Paul Holman, Seattle, WA (US); Roderick A. Hyde, Redmond, WA (US); Keith D. Rosema, Olympia, WA (US); Clarence T. Tegreene, Mercer Island, WA (US); Lowell L. Wood, JR., Bellevue, WA (US)

(73) Assignee: Elwha LLC, Bellevue, WA (US)

(21) Appl. No.: 13/660,880

(22) Filed: Oct. 25, 2012

(51) Int. Cl. H04R 3/00

(52) U.S. Cl. CPC H04R 3/00
USPC 381/74

(57) ABSTRACT

Headsets, systems, devices, and methods for storage and presentation of an audio or visual file are presented. Embodiments relate to storing the audio or visual file in non-volatile memory and playing or displaying the audio or visual file through at least one speaker or display if a playback command is received from an external server or a sensor condition is met. In some embodiments, the playback command is received wirelessly. According to some embodiments, the sensor condition is based on a location or a signal availability.

### BACKGROUND

Receiving files using wireless devices can be problematic. For example, the strength of the wireless connection may vary as the wireless device moves from location to location. Even if a connection is made and the device stays in the same location, connectivity can be intermittent or there may be a weak connection, making successful downloading of a large file difficult or impossible. Additionally, mobile download of files through a wireless connection may be disadvantageous due to bandwidth limitations of a wireless network or power requirements of the transmitting device.

### SUMMARY

Aspects of the headsets, methods, and systems for non-volatile memory in wireless headsets are described herein.

One exemplary embodiment is a headset for storage and presentation of an audio or visual file. The headset includes: at least one speaker or display; non-volatile memory for storing the audio file; and a processor configured to receive the audio file from an external server and play the audio file through the at least one speaker if a playback command is received from the external server.

Another exemplary embodiment is a system for storage and presentation of an audio or visual file. The system includes means for presenting the audio or visual file to a user; means for receiving the audio or visual file from an external server; means for storing the audio or visual file; and means for playing or displaying the audio or visual file through the means for presenting if a playback command is received from the external server.

In another exemplary embodiment, a method relates to storage and presentation of an audio or visual file. The method includes: providing a headset having non-volatile memory and at least one of a speaker and a display; receiving, from an external server, the audio or visual file; storing, in non-volatile memory, the audio or visual file; and playing or displaying the audio or visual file through at least one speaker or display if a playback command is received from the external server.

Another exemplary embodiment is a device for transmitting an audio or visual file. The device includes: a transmitter for transmitting the audio or visual file for storage in a receiving device; wherein the transmitter is further configured to transmit a playback command to the receiving device for triggering the receiving device to play or display the audio or visual file.

Another exemplary embodiment is a system for transmitting an audio or visual file. The system includes: means for transmitting, from a server, the audio or visual file for storage in the receiving device; and means for transmitting, from the server, a playback command, the playback command for triggering the receiving device to play or display the audio or visual file.

In another exemplary embodiment, a method relates to transmitting an audio or visual file. The method includes: transmitting, from a server, the audio or visual file for storage in a receiving device; and transmitting, from the server, a playback command for triggering the receiving device to play or display the audio or visual file that was previously transmitted.

Another exemplary embodiment is a headset for storage and presentation of a visual file. The headset includes: a display; a receiver for receiving the visual file from an external server; non-volatile memory for storing a visual file; and a processor configured to display the visual file through the display if a playback command is received from the external server.

Another exemplary embodiment is a headset for providing audio to a user. The headset includes a speaker; a receiver configured to receive portions an audio stream from an audio streaming source; a non-volatile memory for storing the portions of an audio stream; and a processor configured to store the portions of the audio stream in the non-volatile memory, play the portions of the audio stream based on a playback command, and erase the portions of the audio stream from the non-volatile memory.

The invention is capable of other embodiments and of being practiced or being carried out in various ways. Alternative exemplary embodiments relate to other features and combinations of features as may be generally recited in the claims.

### BRIEF DESCRIPTION OF THE DRAWINGS

FIG. 1 is a schematic diagram of a headset system, according to an exemplary embodiment;

FIG. 2 illustrates a schematic view of a headset for implementing a method of providing audio content to a user of a user device, according to an exemplary embodiment;

FIG. 3 is a flowchart of a method according to an exemplary embodiment, in which playback or display is conditioned on whether a playback command is received;

FIG. 4 is a flowchart of a method according to an exemplary embodiment, in which playback or display is conditioned on whether a sensor condition is met; and.

FIG. 5 is a flowchart of a method according to an exemplary embodiment, in which a sending device transmits a file and a playback command to a receiving device.

### DETAILED DESCRIPTION

The methods, headsets, systems, and devices described herein provide a way of storing and providing audio or visual content to a user of a device, such as a headset. In various embodiments, audio or visual files may be stored in non-volatile memory housed in a set of headphones, headset, or other listening device. The stored audio or visual files may be played, displayed, or otherwise presented to a user. Storing files in the user device in this manner can be used to eliminate the need to transmit commonly used or fixed-content sounds to an earbud or similar listening device, thereby reducing bandwidth or power requirements for the transmitting device. Additionally, storing audio or visual files is beneficial for when a wireless connection is unavailable or lost.

Such methods may be carried out on a headset including circuitry to store and deliver audio or visual content to a user, for example, through a headset, headphones, one or more earbuds, any mobile speaker or set of speakers, PDA, smartphone, any portable media player, any mobile monitor or display, or any combination of those. The speaker(s) may be capable of producing three-dimensional audio effects beyond left channel and right channel. The speaker(s) may be connected to the headset wirelessly or through a wired connection, or the headset may be a single standalone device.

The headset may include a computer headset, which may include one or more integrated circuits or other processors that may be programmable or special-purpose devices. The headset may include memory which may be one or more sets of memory, which may be persistent or non-persistent, such as dynamic or static random-access memories, flash memories, electronically-erasable programmable memories, or the like. Memory in a headset, headset system, or server may having instructions embedded therein, such that if executed by a programmable device, the instructions will carry out methods as described herein to form headsets and devices having functions as described herein.

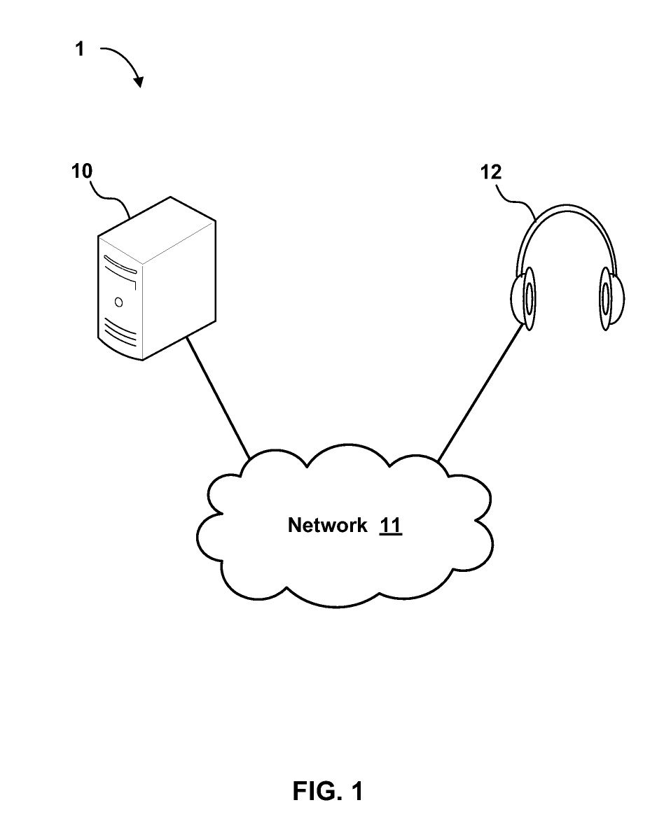

FIG. 1 illustrates a headset according to an exemplary embodiment. As shown in FIG. 1, an exemplary networked headset and server system 1 for implementing processes according to embodiments of the invention may include a general-purpose computing device 10 that interacts with devices through a network 11, such as, but not limited to, a wireless network. Computing device 10 may be a server that communicates over network 11 with one or more user devices 12. A server 10 may be or include one or more of: a general-purpose computer, special-purpose computer, server, mainframe, tablet computer, smartphone, PDA, Bluetooth device, an internet based audio or video service, or the like, including any device that is capable of providing audio or visual files to an external user device 12 over a network. In some embodiments, a server 10 may not be a remote control, as in a remote control for a TV or other audio/visual component. In some embodiments, a server 10 may not be a headset or similar audio communication device.

User device 12 may communicate with computing device 10 through network 11. User device 12 may be a mobile device connected to or include one or more speakers and/or displays. User device 12 may include, but is not limited to, one of more of: a general-purpose computer, special-purpose computer, laptop, tablet computer, smartphone, PDA, Bluetooth device, media player device, radio receiver or other receiver device, a seat providing a port for plugging in headphones or another listening device, headphones, earbuds, and the like, including any device that is capable of providing audio or visual content to a user through a speaker or display which may or may not be attached to user device 12. User device 12 may communicate with one or more servers 10 through one or more applications that include computer-executable instructions. User device 12 may communicate through one or more network interface devices or network interface circuitry. Alternative embodiments may not involve network 11 at all, and may instead be implemented through peer-to-peer communication between user device 12 and a server or between multiple user devices 12. For example, computing device 10 and user device 12 may communicate with each other through infra-red, radio, Bluetooth, wired connections, or the like.

Computing device 10 may be implemented as a network of computer processors. In some implementations, computing device 10 may be multiple servers, mainframe computers, networked computers, a processor-based device, or a similar type of headset or device. In some implementations, computing device 10 may be a server farm or data center. Computing device 10 may receive connections through a load-balancing server or servers. In some implementations, a task may be divided among multiple computing devices 10 that are working together cooperatively.

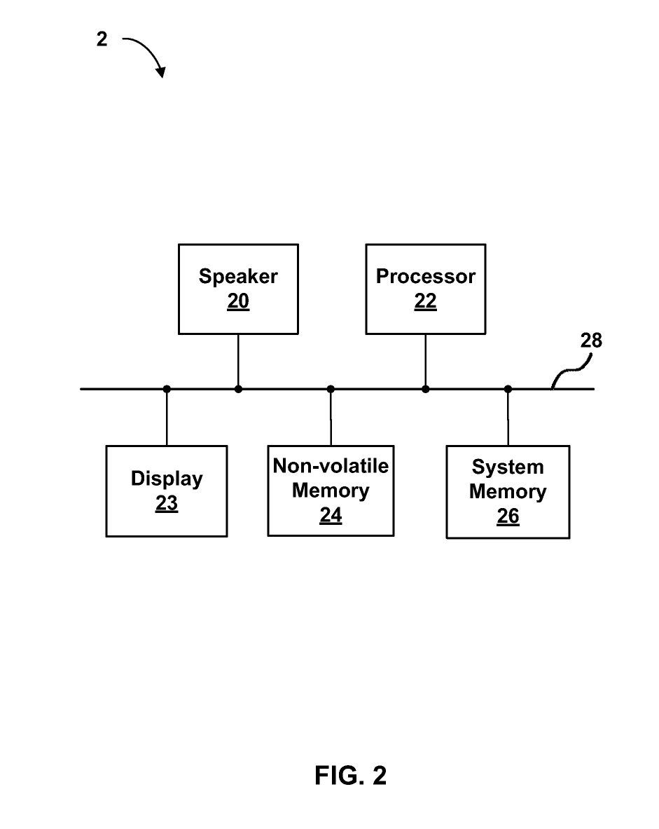

FIG. 2 provides a schematic diagram of a headset according to an exemplary embodiment. As shown in FIG. 2, an exemplary system 2 includes a special-purpose computing device in the form of a headset, including a processing unit 22 or processor, non-volatile memory 24, a memory 26, and a bus 28 that couples various system components to the processing unit 22.

The system memory 26 may include one or more suitable memory devices such as, but not limited to, RAM, or any type of volatile memory or data caching mechanism. The computer may include a non-volatile storage medium 24, such as, but not limited to, a solid state storage device and/or a magnetic hard disk drive (HDD) for reading from and writing to a magnetic hard disk, a magnetic disk drive for reading from or writing to a removable magnetic disk, and an optical disk drive for reading from or writing to removable optical disk such as a CD-ROM, CD-RW or other optical media, flash memory, SD card, USB drive, memory stick, or the like. Storage medium 24 may be one or more sets of non-volatile memory such as flash memory, phase change memory, memristor-based memory, spin torque transfer memory, or the like. A storage medium 24 may be external to the devices 10, 12, such as external drive(s), external server(s) containing database(s), or the like. A storage medium 24 may be on-board memory. The drives and their associated computer-readable media may provide non-transient, non-volatile storage of computer-executable instructions, data structures, program modules, audio and visual files, and other data for the computer to function in the manner described herein. Various embodiments employing software are accomplished with standard programming techniques.

The system 2 may also include one or more audio output devices 20, which may be external or internal to user device 12. For example, as discussed above in regard to FIG. 1, the audio output device(s) 20 may be part of a user device 12. As illustrated in FIG. 2, an audio output device 20 may include one or more speakers. In addition, an audio output device 20 may be any device capable of playing audio content such as music or other sound file, or capable of outputting information that can be used for playing audio content. Devices that output information that can be used for playing audio content include, but are not limited to, networking devices. For example, servers or an internet based audio service may distribute audio files to client devices through networking devices.

User device 12 and computing device 10 may each separately include processor(s) 22, storage medium or media 24, system memory 26, and system bus(es) 28. Computing device 10 may not include an audio output device 20. Computer device 10 may not include a visual output device 23. User device 12 may include one or more audio output devices 20, one or more visual output devices 23, or a combination of devices 20 and 23.

Processor 22 may provide output to one or more visual output devices 23. As illustrated in FIG. 2, a visual output device 23 may be one or more displays. Visual output device 23 may provide output to one or more users or computing devices, and/or may include (but is not limited to) a display such as a CRT (cathode ray tube), LCD (liquid crystal display), plasma, OLED (organic light emitting diode), TFT (thin-film transistor), or other flexible configuration, or any other monitor or display for displaying information to the user. Visual output device 23 may be part of a computing device (as in the case of a laptop, tablet computer, PDA, smartphone, or the like). Visual output device 23 may be external to a computing device (as in the case of an external monitor or television). In addition, a visual output device 23 may be any device capable of displaying visual content such as a video or image or capable of outputting information that can be used for the display of visual content. Visual output device 23 may be incorporated within a user worn headset. A headset mounted visual output device may comprise an image projector, this may direct the image into the user's eye, onto a headset-mounted reflector, onto an external surface visible to the user, or the like. A headset mounted visual output device may comprise a heads-up display, presenting the image into the user's eyepath via a visor, eyeglasses, goggles, or the like. A headset mounted visual output device may comprise a mechanically repositionable display surface, such as a flip-down display or reflector. Devices that output information that can be used for the display of visual content include, but are not limited to, networking devices, such as network interface devices or network interface circuitry. For example, a server may distribute a visual file to a client device through networking device.

According to various embodiments, computer-executable instructions may encode a process of securely sharing access to information. The instructions may be executable as a standalone, computer-executable program, as multiple programs, as mobile application software, may be executable as a script that is executable by another program, or the like.

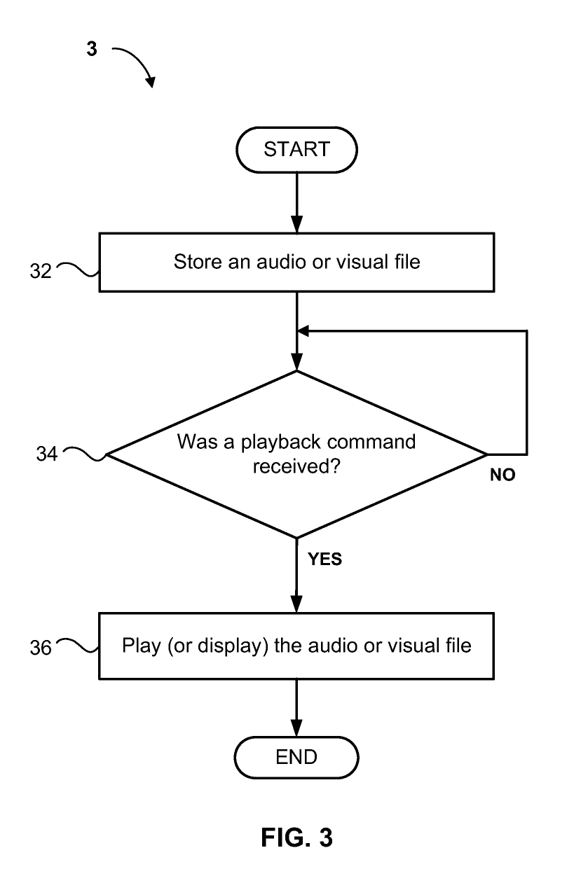

With reference to FIG. 3, a method for storage and presentation of an audio or visual file according to various embodiments is implemented by a user device 12 according to a process 3. A processor 22 may execute instructions that instruct information to be saved to non-volatile memory 24.

Processor 22 may cause one or more audio or visual files to be stored in non-volatile memory 24 (step 32). The file may include a sound file, a sound or video stream, or clip, video, image, photo, over the air radio streams, chunk(s) or portion(s) of any of those, any combination of those, or the like. The file may be in any format in which audio or visual content can be expressed, such as WAV, AIFF, IFF, AU, PCM, FLAC, WavPack, TTA, ATRAC, AAC, ATRAC, WMA, BWF, SHN, XMF, FITS, 3GP, ASF, AVI, DVR-MS, FLV, F4V, IFF, MKV, MJ2, QuickTime, MP3, MP4, RIFF, MPEG, Ogg, RM, NUT, MXF, GXF, ratDVD, SVI, VOB, DivX, JPEG, Exif, TIFF, RAW, PNG, GIF, BMP, PPM, PGM, PBM, PNM, WEBP, or the like. The file may be a container or wrapper for one or more videos, audio files, images, movies, photos, any combination of those, or the like.

The audio or visual file may contain a ringtone, visual alert, sound effect, visual effect, game sound effect, game visual effect, monologue, dialogue, conversation, informational message, advertisement, or the like.

The audio or visual file may have been preinstalled onto the non-volatile memory 24 before the user device was delivered to a retailer. The audio or visual file may have been preinstalled by a retailer before being delivered to a consumer. A user may download or copy an audio or visual file onto the non-volatile memory 24. The audio or visual file may be recorded onto non-volatile memory 24. The audio or visual file may be removed or added by changing non-volatile memory 24. The audio or visual file may be removed from non-volatile memory according to an expiration schedule. In one embodiment, the expiration schedule is based on a time lapse from a time the audio or visual file, or a portion of the audio or visual file, was stored on non-volatile memory 24 or transferred to the user device. In another embodiment, the expiration schedule is embedded within the audio or visual file. In another embodiment, the expiration schedule is based on user input. In another embodiment, the expiration schedule is provided by a second device (e.g., server 10, etc.). For example, an audio stream transferred from an internet-based audio streaming service may expire after one week. In another example, the audio file may expire after a certain number of plays. In another embodiment, the expiration schedule is based on the capacity of non-volatile memory. For example, if a second audio or visual file is downloaded, and space is needed on non-volatile memory 24 to store the second audio or visual file, a first audio or visual file may expire and be removed from non-volatile memory in order to free up storage space. An expiration schedule may correspond to an entire audio or visual file, or to portions of the audio or visual file.

The audio or visual file may be transmitted from a server 10 and received by a user device 12, which stores the file on non-volatile memory 24. As an example, server 10 may be part of an internet based audio or video service. The file may have been transferred wirelessly or over a wired connection. The file may be received by user device 12 from a transmitter that is external to user device 12.

Processor 22 determines whether a playback command has been received by the user device 12 (step 34). The playback command may be received from server 10. If a playback command was not received, step 34 is repeated. User device 12 waits until a playback command is received. User device 12 may perform other functions while waiting for a playback command or it may be idle. A playback command may be received wirelessly or through a wired connection, or through a combination of wired and wireless connections. The playback command may not be transmitted from the server until a time after the audio or visual file has been stored on the user device 12. For example, the audio or visual file may be downloaded before a scheduled performance or event, and the playback command may be transmitted at the appropriate time at the start or during the performance or event.

A playback command may specify an audio or visual file to be played or displayed, and may include a user selection. The playback command may specify a portion of the audio or visual file to be played or displayed. The playback command may specify a time, or delay until, the audio or visual file is to be played or displayed. The playback command may include commands for pausing, stopping, starting, fast-forwarding, rewinding, or restarting playback. The playback command may be based on a user gesture, user input, a mechanical switch, or sound, etc. User device 12 determines whether the specified file is already stored in non-volatile memory 24. If it is not already stored, the user device 12 transmits a request for the file to be sent to the user device 12. The request is sent to server 10. Server 10 may send, and the user device 12 may receive, a copy of the requested file after the server receives the request. The user device 12 may store this received audio or visual file in the non-volatile memory 24. The received file may be played or displayed (step 36).

If a copy of the file specified in the playback command is already in the non-volatile memory 24, the user device 12 may transmit a request to not send the same file. The request may be transmitted to and received by server 10. Server 10, after receiving this request, may stop transmitting the file or determine to not transmit the file.

Upon receiving part of an audio or visual file, user device 12 may determine that a copy of the file is already in the non-volatile memory 24 and transmit a request to stop sending the file. The server 10, after receiving this request, may stop transmitting the file. If user device 12 determines that a copy of the file is not already in the non-volatile memory 24, user device 12 may continue to receive the file. The received file may be stored in non-volatile memory 24. The received file may be played or displayed (step 36).

If part of the audio or visual file is received, the received portion may be played or displayed, or may include a file header. The file header may be used to determine whether a copy of the file is already in the non-volatile memory 24.

If part of the audio or visual file is received, the received portion may be used for comparison, such as for pattern recognition. The comparison can be used to determine whether a copy of the file is already in non-volatile memory 24. For instance, the first few bars of a song may be transmitted, and that may be used to compare against stored files, such as music files.

If an audio or visual file is received, it may supplant another file in the non-volatile memory. The supplanted file may be another audio or visual file. Whether any or a particular audio visual file is supplanted may depend on a user command. For example, the user may specify whether to supplant a file or discard the incoming file. Determining whether to supplant a file may be based on the amount of available (or “free”) file space there is in the non-volatile memory 24. For instance, if there is enough available memory to save the incoming file without removing the existing files in non-volatile memory 24, then the incoming file may be saved without supplanting any files in the non-volatile memory 24.

If a file is to be supplanted, a user may specify which file to supplant. If a file is to be supplanted, the file chosen to be supplanted may be determined based on a priority of the files. For instance, a file with low priority may be supplanted before a file with a higher priority is selected to be supplanted. If a file is to be supplanted, the file chosen to be supplanted may be determined based on a usage frequency of the files. For instance, a file used less frequently may be supplanted before a file that is more frequently accessed. If a file is to be supplanted, the file chosen to be supplanted may be determined based on the ages of the files. For example, a file that is older may be supplanted before a file that is newer.

If a playback command is received, then the user device 12 may play or display an audio or visual file (step 36). The file may be played or displayed through an audio output device 20 or a visual output device 23. For example, if an audio file is received, the audio represented by the data in the file may be output to one or more speakers or to a device for interpreting or transmitting audio. As another example, if a video file is received, the video represented by the data in the file may be output to a display and its sound track output to one or more speakers or to devices for interpreting or transmitting video and/or audio.

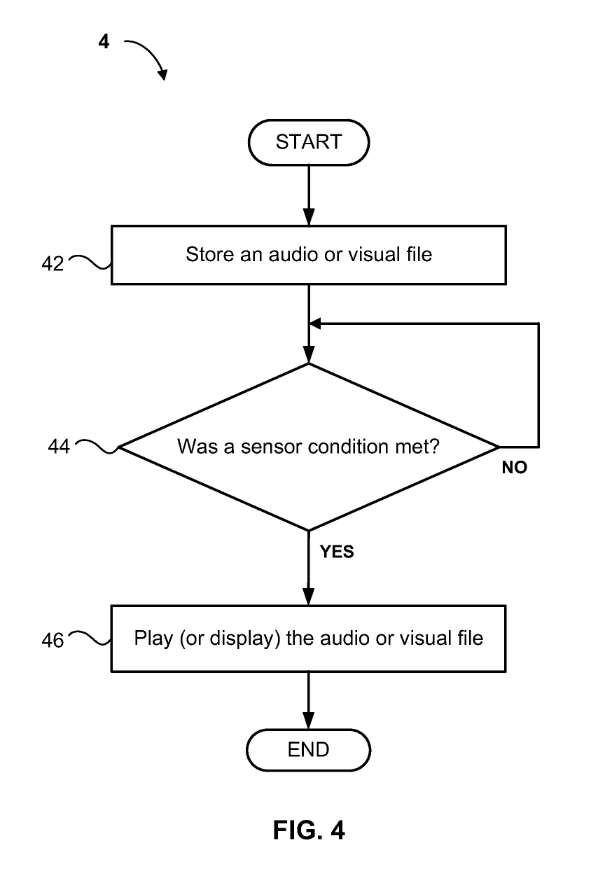

With reference to FIG. 4, a method for storage and presentation of an audio or visual file according to various embodiments is implemented by a user device 12 according to a process 4. A processor 22 may execute instructions that instruct information to be saved to non-volatile memory 24. Storing an audio or visual file (step 42) is described above in relation to step 32 of process 3.

The processor 22 determines whether a sensor condition has been met (step 44). If a sensor condition has not been met, step 44 may be repeated. A user device 12 may wait until a sensor condition has been met. A user device 12 may perform other functions while waiting for a sensor condition to be met, or the user device 12 may be idle. A user device 12 may include one or more sensors or may receive data from one or more sensors. A sensor condition may be based on data received from one or more sensors. The sensor condition may be pre-stored in the processor 22 or the non-volatile memory 24. The sensor condition may be received via an external transmission; this can be included within the playback command, or can be delivered by a separate signal. The sensor condition may be based on any number of conditions, including, but not limited to, location data or signal information (e.g., signal strength, type of signal, signal bandwidth, etc.). It should be understood that the scope of the present application is not limited to a certain sensor condition.

For instance, the sensor may be a Global Positioning System (GPS) device or other location-determining device. The sensor condition may be based on the sensed location. For example, if the GPS senses that it is located in a particular location, and the sensor condition is based on being in that area, then the user device 12 may play or display an audio or visual file (step 46). That may be useful, for instance, in an art museum, or other tour situation, in which a user has a headset or other user device 12 which plays an audio file or displays a video when the user device 12 is located in an appropriate area. The audio or visual file may be related to an exhibit near the location of the user device 12. In a tour situation, for example, required or popular files may already be stored on non-volatile memory 24 of a headset 12 so that they need not be downloaded during the tour.

As another example, a sensor condition may be based on the availability of a signal. For instance, if a wireless data connection is unavailable, the user device 12 may play or display audio or visual file(s) that are already stored in the non-volatile memory (step 46). This allows the user to use available files without having to wait for a connection to become available so that the user may download a file. As another example, if a cell phone connection becomes unavailable, a notification sound may automatically play. For instance, an informational message may be played, such as “You have temporarily lost cell phone connectivity.”

In yet another example, a sensor condition may be based on bandwidth availability. For example, if the bandwidth available in a connection is low, the user device 12 may play or display audio or visual files that are already stored in the non-volatile memory (step 46). This allows the user to use available files without having to wait for more bandwidth to become available so that the user may download a file.

If a sensor condition has been met, then user device 12 may play or display an audio or visual file (step 46). The sensor condition may cause user device 12 to play or display the audio or visual file (i.e., the sensor condition may be interpreted by the processor of user device 12 as a playback command, or other command, etc.). This has been described above in relation to step 36 of process 3.

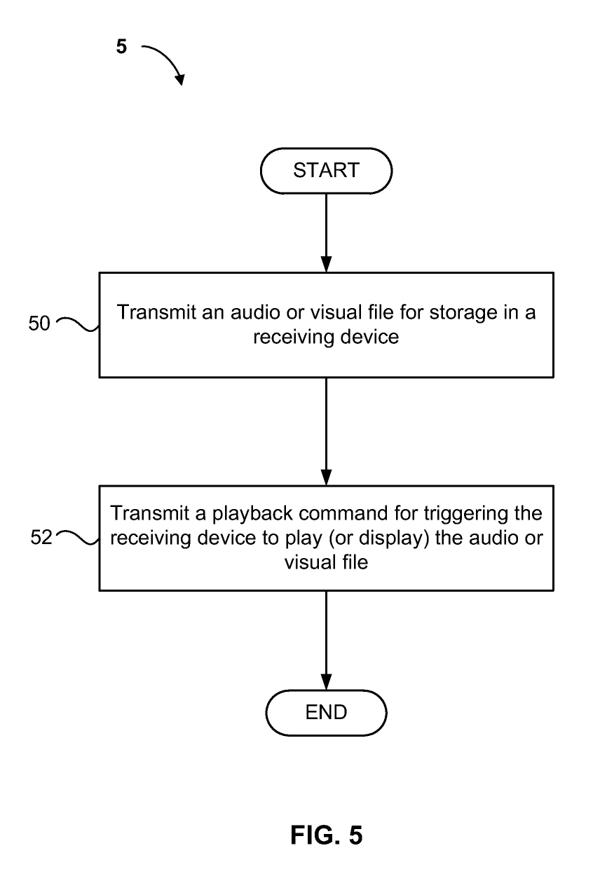

With reference to FIG. 5, a method for transmitting an audio or visual file according to various embodiments is implemented by server 10 according to process 5. Processor 22 may execute instructions that instruct a transmitter or network interface device to transmit information to user device 12.

Server 10 transmits an audio or visual file for storage in a receiving user device 10 (step 50). The audio or visual file may be as discussed above, in relation to process 3 of FIG. 3. The audio or visual file may be transmitted wirelessly, over a wired connection, or over a combination of wireless and wired connections. The audio or visual file is transmitted to user device 12. User device 12 may be external to the server 10. Instead of transmitting an entire file, a portion of the file may be transmitted, as discussed above in relation to process 3 of FIG. 3.

Server 10 may transmit a playback command for triggering the receiving device to play or display an audio or visual file (step 52). The playback command may be as discussed above, in relation to process 3 of FIG. 3. The playback command may be transmitted wirelessly, over a wired connection, or over a combination of wireless and wired connections. The playback command may be transmitted to user device 12.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

The above-described embodiments may be implemented using hardware or circuitry, software, or a combination thereof. When implemented in software, the software code may be executed on any suitable processor or collection of processors, whether provided in a single computer system (“computer”) or distributed among multiple computers.

Further, it should be appreciated that a computer may be embodied in any of a number of forms, such as a rack-mounted computer, mainframe, a desktop computer, a laptop computer, a server computer, a cloud-based computing environment, a tablet computer, etc.

Additionally, a computer may be embedded in a device not generally regarded as a computer but with suitable processing capabilities, including a Personal Digital Assistant (PDA), a smart phone, or any other suitable portable or fixed electronic device.

Various embodiments may include hardware devices, as well as program products including computer-readable, non-transient storage media for carrying or having data or data structures stored thereon for carrying out processes as described herein. Such non-transient media may be any available media that can be accessed by a general-purpose or special-purpose computer or server. By way of example, such non-transient storage media may include random-access memory (RAM), read-only memory (ROM), erasable programmable read-only memory (EPROM), electrically erasable programmable read-only memory (EEPROM), field programmable gate array (FPGA), flash memory, compact disk, or other optical disk storage, magnetic disk storage or other magnetic storage devices, or any other medium which can be used to carry or store desired program code in the form of computer-executable instructions or data structures and which can be accessed by a general-purpose or special-purpose computer. Combinations of the above may also be included within the scope of non-transient media. Volatile computer memory, non-volatile computer memory, and combinations of volatile and non-volatile computer memory may also be included within the scope of non-transient storage media. Computer-executable instructions may include, for example, instructions and data that cause a general-purpose computer, special-purpose computer, or special-purpose processing device to perform a certain function or group of functions.

In addition to a system, various embodiments are described in the general context of methods and/or processes, which may be implemented in some embodiments by a program product including computer-executable instructions, such as program code. These instructions may be executed by computers in networked environments. The terms “method” and “process” are synonymous unless otherwise noted. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

In some embodiments, the method(s) and/or system(s) discussed throughout may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments may encompass many types of computer system configurations, including personal computers, hand-held devices, multi-processor systems, microprocessor-based or programmable consumer electronics, network personal computers, minicomputers, mainframe computers, and the like.

In some embodiments, the method(s), system(s), device(s) and/or headset(s) discussed throughout may be operated in distributed computing environments in which tasks are performed by local and remote processing devices that may be linked (such as by wired links, wireless links, or by a combination of wired or wireless links) through a communications network. Specifically, computing device 10 and user device 12 may communicate wirelessly or through wired connection(s). Communication may take place using a Bluetooth standard or the like.

In a distributed computing environment, according to some embodiments, program modules may be located in both local and remote memory storage devices. Data may be stored either in repositories and synchronized with a central warehouse optimized for queries and/or for reporting, or stored centrally in a database (e.g., dual use database) and/or the like.

The various methods or processes outlined herein may be coded and executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. The computer-executable code may include code from any suitable computer programming or scripting language or may be compiled from any suitable computer-programming language, such as, but not limited to, ActionScript, C, C++, C#, Go, HTML, Java, JavaScript, JavaScript Flash, JSON, Objective-C, Perl, PHP, Python, Ruby, Visual Basic, and XML.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above. The recitation of a module, logic, unit, or circuit configured to perform a function includes discrete electronic and/or programmed microprocessor portions configured to carry out the functions. For example, different modules or units that perform functions may be embodied as portions of memory and/or a microprocessor programmed to perform the functions. Alternatively, circuitry may perform all of the functions that a processor is described as performing herein.

Additionally, it should be appreciated that according to one aspect, one or more computer programs that, when executed, perform methods of the present invention, need not reside on a single computer or processor, but may be distributed in a modular fashion amongst a number of different computers or processors to implement various aspects of the present invention.

Although the foregoing is described in reference to specific embodiments, it is not intended to be limiting or disclaim subject matter. Rather, the invention as described herein is defined by the following claims, and any that may be added through additional applications. The inventors intend no disclaimer or other limitation of rights by the foregoing technical disclosure.

1. A headset for storage and presentation of an audio file, comprising:
a speaker;
non-volatile memory for storing an audio file; and
a processor configured to receive the audio file from an external server and play the audio file through the speaker if a playback command is received from the external server.

2. The headset of claim 1, further comprising:
a receiver for receiving the playback command wirelessly.

3-7. (canceled)

8. The headset of claim 1, wherein the playback command specifies an audio file to be played.

9. The headset of claim 8, wherein the processor is further configured to:
transmit, if the audio file is not stored in the non-volatile memory, a request to send the audio file; and
receive the audio file.

10. The headset of claim 9, wherein the processor is further configured to:
store the received audio file in the non-volatile memory.

11. The headset of claim 8, wherein the processor is further configured to:
transmit, if the audio file is stored in the non-volatile memory, a request to not send or to stop sending the audio file.

12. The headset of claim 8, wherein the processor is further configured to:
receive a portion of the audio file; and
determine, based on the received portion, whether the audio file is stored in the non-volatile memory.

13. The headset of claim 12, wherein the processor is further configured to:
store the received portion of the audio file in the non-volatile memory.

14. The headset of claim 12, wherein the processor is further configured to:
play the received portion of the audio file.

15. The headset of claim 12, wherein the received portion of the audio file comprises a file header; and
wherein determining whether the audio file is stored in the non-volatile memory is based on the file header.

16-18. (canceled)

19. The headset of claim 1, further comprising a sensor, and wherein the processor is further configured to play the audio file based upon a sensor condition.

20. The headset of claim 19, wherein the processor is configured to play the audio file if both the playback command is received and the sensor condition is met.

21. The headset of claim 19, wherein the sensor condition is based on location data.

22-24. (canceled)

25. The headset of claim 1, the processor further configured to:
receive the audio file; and
store the audio file in the non-volatile memory.

26-28. (canceled)

29. The headset of claim 25, wherein the processor is further configured to determine whether to supplant a second audio file on the non-volatile memory with the audio file, based on at least one of: a user command, a priority, a usage frequency, an age, or an amount of available file space.

30-143. (canceled)

144. A headset for storage and presentation of a visual file, comprising:
a display;
a receiver for receiving the visual file from an external server;
non-volatile memory for storing the visual file; and
a processor configured to display the visual file through the display based on a playback command received from the external server.

145. The headset of claim 144, further comprising a receiver for receiving the playback command wirelessly.

146-147. (canceled)

148. The headset of claim 144, wherein the playback command specifies a visual file to be displayed.

149. The headset of claim 148, wherein the processor is further configured to:
transmit, if the visual file is not stored in the non-volatile memory, a request to send the visual file; and
receive the requested visual file.

150. (canceled)

151. The headset of claim 148, wherein the processor is further configured to transmit, if the visual file is stored in the non-volatile memory, a request to not send or to stop sending the visual file.

152. The headset of claim 148, wherein the processor is further configured to:
receive a portion of the visual file; and
determine, based on the received portion of the visual file, whether the visual file is stored in the non-volatile memory.

153-154. (canceled)

155. The headset of claim 152, wherein the received portion of the visual file comprises a file header; and
wherein determining whether the visual file is stored in the non-volatile memory is based on the file header.

156-158. (canceled)

159. The headset of claim 144, further comprising a sensor, and wherein the processor is further configured to display the visual file based upon a sensor condition.

160. The headset of claim 159, wherein the processor is further configured to play the visual file if both the playback command is received and a sensor condition is met.

161. The headset of claim 159, wherein the sensor condition is based on location data.

162-168. (canceled)

169. The headset of claim 144, wherein the processor is further configured to determine whether to supplant a second visual file on the non-volatile memory with the visual file, based at least one of: a user command, a priority, a usage frequency, an age, or an amount of available file space.

170-180. (canceled)

181. A headset for providing audio to a user, comprising:
a speaker;
a receiver configured to receive an audio stream from an audio streaming source;
a non-volatile memory for storing portions of the audio stream; and
a processor configured to:
store the portions of the audio stream in the non-volatile memory;
play the portions of the audio stream based on a playback command; and
erase the portions of the audio stream from the non-volatile memory.

182. The headset of claim 181, wherein the processor is further configured to erase the portions of the audio stream from the non-volatile memory based on an expiration schedule.

183. The headset of claim 181, wherein the expiration schedule is provided by the audio streaming source.

184. The headset of claim 181, wherein the expiration schedule is embedded within the portions of the audio stream.

185. The headset of claim 181, wherein the expiration schedule is based on user input.

186. The headset of claim 181, wherein the expiration schedule is based on a capacity of the non-volatile memory.

187. The headset of claim 181, wherein the expiration schedule corresponds to a certain portion of the audio stream.

188. The headset of claim 187, wherein the expiration schedule is based on a time lapse from a time received of the portions of the audio stream.

189. The headset of claim 181, wherein the playback command includes a user selection.

190. (canceled)

191. The headset of claim 181, wherein the playback command is based on a gesture.

192. (canceled)

193. The headset of claim 181, wherein the playback command is based on a sound.

194. (canceled)

195. The headset of claim 181, wherein the audio streaming source includes an internet based audio service.

196. The headset of claim 181, wherein the receiver is further configured to receive the playback command.

197-199. (canceled)

200. The headset of claim 181, further comprising a transmitter, and wherein the processor is further configured to:
transmit using the transmitter, if a portion of the audio stream audio stream is not stored in the non-volatile memory, a request to send the portion of the audio stream audio stream; and
receive the requested portion of the audio stream.

201. (canceled)

202. The headset of claim 200, wherein the processor is further configured to transmit using the transmitter, if the portion of the audio stream audio stream is stored in the non-volatile memory, a request to not send or to stop sending the portion of the audio stream audio stream.

203. The headset of claim 181, wherein the processor is further configured to:
determine, based on the portions the audio stream, whether the audio stream is stored in the non-volatile memory.

204. The headset of claim 203, wherein the portions the audio stream include a file header; and
wherein determining whether the audio stream is stored in the non-volatile memory is based on the file header.

205-207. (canceled)

208. The headset of claim 181, further comprising a sensor, wherein the processor is further configured to play the portions of an audio stream based on a sensor condition.

209. The headset of claim 208, wherein the processor is further configured to play the portions of an audio stream if both the playback command is received and the sensor condition is met.

210. The headset of claim 208, wherein the sensor condition is based on location data.

211-216. (canceled)

217. The headset of claim 181, wherein the processor is further configured to determine whether to supplant a second audio stream on the non-volatile memory with the audio stream, based at least one of: a user command, a priority, a usage frequency, an age, or an amount of available file space.

218-225. (canceled)
